(19) United States
(12) Patent Application Publication
(10) Pub. No.: US 2004/0038696 A1
(43) Pub. Date: Feb. 26, 2004

(54) Transmitter

(75) Inventors: Yasunori Suzuki, Yokohama-shi (JP); Tetsuo Hirota, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/647,259

(22) Filed: Aug. 26, 2003

(30) Foreign Application Priority Data
Aug. 26, 2002 (JP) 2002-244754

(51) Int. Cl. H04B 7/00

(52) U.S. Cl. 455/521

(57) ABSTRACT

A transmitter comprises: an N-channel input side multi-port directional coupler which inputs thereto transmission signals of N channels and outputs signals of N channels, the input side multi-port directional coupler being implemented by digital signal processing. Digital signal processing type predistorters of N channels for linearizing respective transmission channels; digital-to-analog converters of N channels which input thereto the output signals from the digital signal processing type predistorters of N channels; and transmitting parts of N channels each including the output signal from the corresponding one of the digital-to-analog converters of N channels and an amplifier; and an N-channel output side multi-port power combiner which inputs thereto the output signals from the transmitting parts of N channels and outputs signals of N channels.

### BACKGROUND OF THE INVENTION

1. Technical Field

The present invention relates to a radio base station transmitter having N transmission channels and, more particularly, to a radio base station transmitter adapted to suppress the creation of nonlinear distortions by power amplifiers.

2. Prior Art

A multi-port amplifier configuration has been proposed which permits reduction of the power consumption of N-channel amplifiers and implementation of their redundant configuration.

FIGS. 1 and 2 show conventional multi-port amplifiers disclosed in Japanese Patent Application Laid-Open No. 10-209777.

Letting N represent an integer equal to or greater than 2, the multi-port amplifier comprises: an input side multi-port directional coupler 10 which divides and combines N input signals x₁, . . . , X_{N} into signals of N channels; N amplifiers 33₁, . . . , 33_{N} which amplify the output signals of the N channels by parallel operation; an output side multi-port directional coupler 40 which divides and combines the outputs from the N amplifiers to provide N output signals u₁, . . . , u_{N}; and linearizers 20₁, . . . , 20_{N} each provided in the stage preceding one of the N amplifiers, for preimparting a compensating distortion to the signal of one of the N channels to cancel a nonlinear distortion which is created by the amplifier.

The input side digital multi-port directional coupler 10 can be formed by one or more π/2 hybrids HB each having two input ports IP₁, IP₂ and two output ports OP₁, OP₂ as shown in FIG. 2A. The relationships between two inputs x₁, x₂ and two outputs y₁, y₂ of the π/2 hybrid HB are expressed by the following equation.

$$[ \frac{{y}_{1}}{{y}_{2}} ] = \frac{1}{\sqrt{2}} [ \begin{matrix}1 & j \\ j & 1\end{matrix} ] [ \begin{matrix}{x}_{1} \\ {x}_{2}\end{matrix} ] = \frac{1}{\sqrt{2}} [ \begin{matrix}{x}_{1} + j {x}_{2} \\ j {x}_{1} + {x}_{2}\end{matrix} ] \qquad ( 1 )$$

where the complex number x represents a π/2 phase shift. That is, the signal x₁ to the first input port IP₁ is divided into two, one of which is output to the first output port OP₁ of the original channel in phase with the input signal x₁ and the other of which is output to the second output port OP₂ π/2 out of phase with the input signal x₁. Similarly, the input signal x₂ to the second input port IP₂ is divided into two, one of which is output to the second output port OP₂ of the original channel in phase with the input signal x₂ and the other of which is output to the second output port OP₁ π/2 out of phase with the input signal x₂. Setting a matrix T₁ to

$${T}_{1} = \frac{1}{\sqrt{2}} [ \begin{matrix}1 & j \\ j & 1\end{matrix} ] \qquad ( 2 )$$

a four-port (4 inputs, 4 outputs) directional coupler can similarly be formed by four π/2 hybrids as depicted in FIG. 2B. The input and output signals can be expressed the following relationships.

$$\begin{matrix}[ \begin{matrix}{y}_{1} \\ {y}_{2} \\ {y}_{3} \\ {y}_{4}\end{matrix} ] = \frac{1}{\sqrt{2}} [ \begin{matrix}{T}_{1} & j {T}_{1} \\ j {T}_{1} & {T}_{1}\end{matrix} ] [ \begin{matrix}{x}_{1} \\ {x}_{2} \\ {x}_{3} \\ {x}_{4}\end{matrix} ] \\ = \frac{1}{\sqrt{2}} [ \begin{matrix}1 & j & j & - 1 \\ j & 1 & - 1 & j \\ j & - 1 & 1 & j \\ - 1 & j & j & 1\end{matrix} ] [ \begin{matrix}{x}_{1} \\ {x}_{2} \\ {x}_{3} \\ {x}_{4}\end{matrix} ] \\ = \frac{1}{\sqrt{2}} [ \begin{matrix}{x}_{1} + j {x}_{2} + j {x}_{3} - {x}_{4} \\ j {x}_{1} + {x}_{2} - {x}_{3} + j {x}_{4} \\ j {x}_{1} - {x}_{2} + {x}_{3} + j {x}_{4} \\ - {x}_{1} + j {x}_{2} + j {x}_{3} + {x}_{4}\end{matrix} ]\end{matrix} \qquad ( 3 )$$

where the coefficient −1 of x represent the opposite phase and j the π/2 phase shift.

In general, setting N=2ⁿ, an N-port directional coupler can be formed uniquely by n2ⁿ⁻¹ π/2 hybrids, and its transformation matrix Tₙ can be expressed by the following equation using Tₙ₋₁.

$${T}_{n} = \frac{1}{\sqrt{2}} [ \begin{matrix}{T}_{n - 1} & j {T}_{n - 1} \\ j {T}_{n - 1} & {T}_{n - 1}\end{matrix} ] \qquad ( 4 )$$

FIG. 2C shows a modified form of the four-port directional coupler, in which the multi-port directional couplers 10 and 20 are connected in cascade and the outputs y₁, y₂, y₃ and y₄ from the first-stage directional coupler 10 are input to the second-stage directional coupler 40 to obtain the original input signals x₁, x₂, x₃ and x₄. The matrix connection of the π/2 hybrid forming such a directional coupler is called Butler's matrix.

The conventional multi-port amplifier of FIG. 1, which utilizes the distribution of sending power among the transmission channels, uniformly divides or distributes the input power of each channel by the input side multi-port directional coupler 10 to the N channels. This permits reduction of the saturation output from each amplifier and reduction of the overall power consumption of the amplifiers of the N channels as compared with the power consumption in the case where amplifiers of N channels are each provided independently of the others. Furthermore, even if the amplifier of one of the N channels fails, the dividing of each input signal xₙ (where n=1, . . . , N) by the input-side multi-port directional coupler 10 to N channels ensures power amplification by the amplifiers of the other channels. That is, it is known that the multi-port amplifier itself has a redundant configuration. Moreover, the overall efficiency of the multi-port amplifier improves through compression of the required output backoff by the linearizers 20₁, . . . , 20_{N}.

The conventional multi-port amplifier of FIG. 1 has a configuration in which individual amplifiers 33₁, . . . , 33_{N} of the multi-port amplifier are linearized. Each linearizer 20ₙ is usually a predistorter since it is provided at the input side of each amplifier. In accordance with the input signal to the amplifier the predistorter linearizes its AM/AM conversion characteristic (an input amplitude-output amplitude characteristic) and AM/PM conversion characteristic (an input amplitude-output phase characteristic). The multi-port amplifier of FIG. 1 calls for the use of the predistorter which operates in the sending frequency band.

It is of prime importance to manufacture small and light-weight N-channel transmitters. In particular, an adaptive array transmitter needs to be provided with many independent transmission channels; therefore, each transmitter must be as compact as possible. Even if the FIG. 1 multi-port configuration with predistorters are used in N transmission channels, it is necessary to form the entire channel by analog circuitry. But difficulty is encountered in implementing the whole system by one digital signal processing circuit containing a modulator and to reduce the number of parts used. To afford a sufficiently high degree of isolation between the output ports of the input side digital multi-port directional coupler 10, its gain and phase deviations between channels need to be adjusted to be sufficiently smaller than predetermined values, and the manufacture of such multi-port directional couplers in large numbers requires a circuit configuration that permits simplification of such adjustments.

### SUMMARY OF THE INVENTION

The transmitter according to the present invention comprises:

an input-side digital multi-port directional coupler for dividing and combining digital transmission signals of N channels by digital processing and for outputting N-channel signals to N transmission channels, respectively;

predistorters inserted in said N transmission channels, respectively, for linearizing said N transmission channels;

transmitting parts inserted in said N transmission channels, respectively, for converting output signals from said predistorters to high-frequency signals of said N channels; and

an output-side multi-port power combiner for dividing and combining said high-frequency signals of said N-transmission channels to output high-frequency transmission signals for said N transmission channels.

### BRIEF DESCRIPTION OF THE DRAWINGS

FIG. 1 is a block diagram showing the configuration of a conventional multi-port amplifier;

FIG. 2A is a a diagram explanatory of a π/2 hybrid;

FIG. 2B is a block diagram showing the configuration of a four-port directional coupler;

FIG. 2C is a diagram explanatory of a cascade connection of directional couplers;

FIG. 3 is a block diagram illustrating a basic functional configuration of the transmitter according to the present invention;

FIG. 4 is a block diagram depicting a first embodiment of the transmitter according to the present invention;

FIG. 5 is a block diagram showing an example of the configuration of a transmitting part;

FIG. 6 is a block diagram showing an example of the configuration of a receiving part;

FIG. 7 is a block diagram depicting an example of the configuration of a predistorter;

FIG. 8 is a block diagram depicting a second embodiment of the transmitter according to the present invention; and

FIG. 9 is a block diagram depicting a third embodiment of the transmitter according to the present invention.

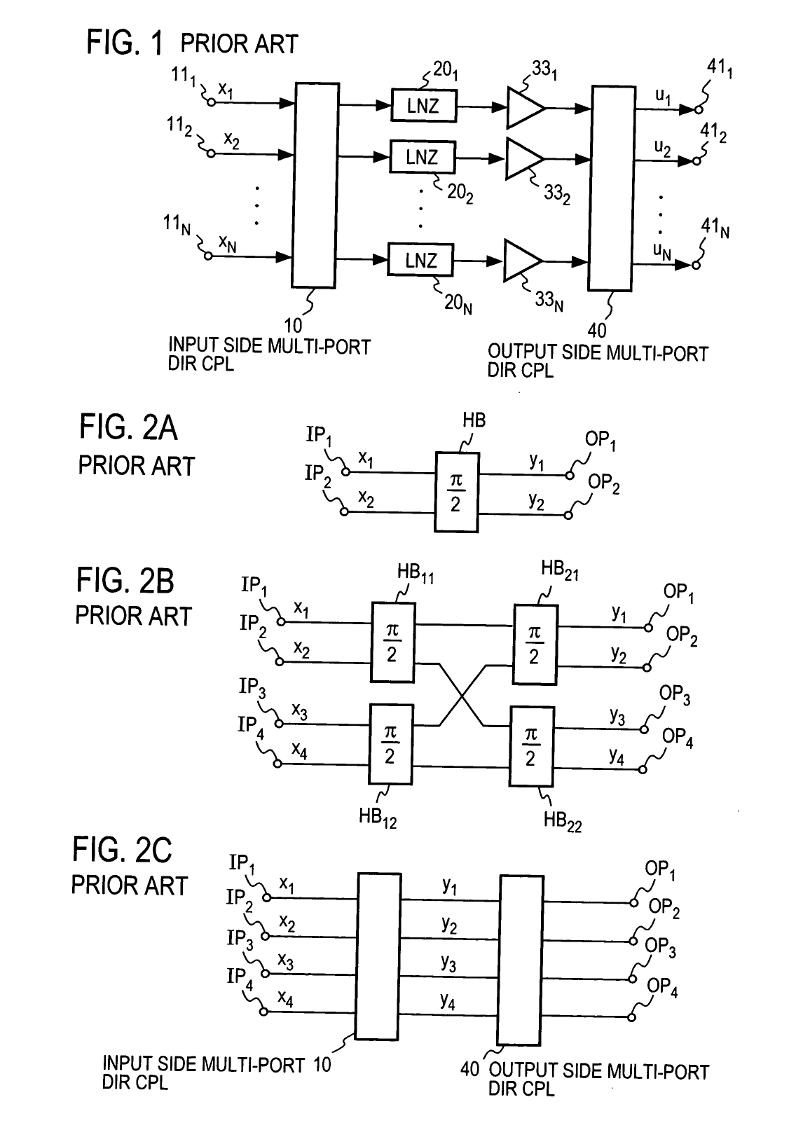

### DETAILED DESCRIPTION OF THE PREFERRED EMBODIMENT

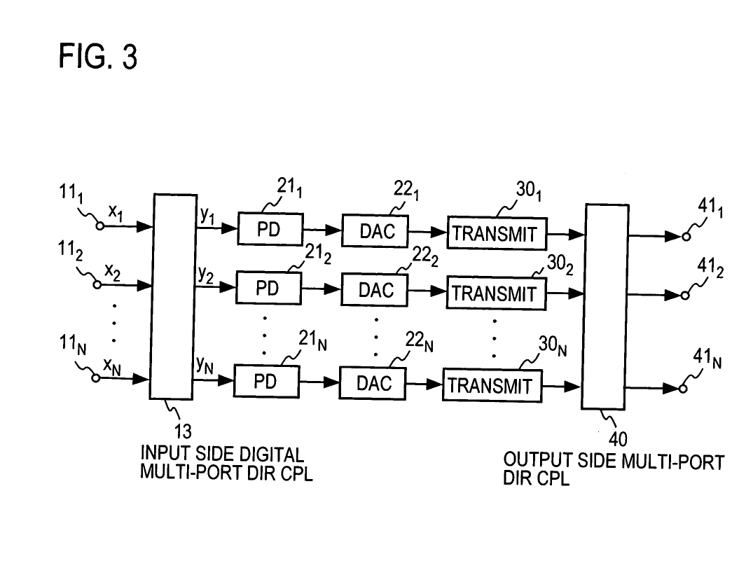

FIG. 3 illustrates a basic functional configuration of the transmitter according to the present invention. The transmitter comprises: an input side digital multi-port directional coupler 13 which divides and combines input digital signals of N channels to provide output signals of N channels; predistorters 21₁, . . . , 21_{N} which impart compensating distortions to the N-channel output signals, respectively; digital-to-analog (DA) converters 22₁, . . . , 22_{N} which convert the outputs to analog signals; transmitting parts 30₁, . . . , 30_{N} which output the outputs from the DA converters as high-frequency signals; and an output side multi-port directional coupler 40 which divides and combines the outputs from the N-channel transmitting parts and sends N-channel high-frequency signals to N antennas (not shown), respectively.

As will be seen from the above, in the present invention the signal processing by the input side digital multi-port directional coupler 13 and the predistorters 21₁, . . . , 21_{N} is digital processing. By performing the function of the multi-port directional coupler 13 through digital processing, it is possible to achieve characteristics of the multi-port directional coupler with ideal gain and phase deviations.

In the following description, letting discrete time t be represented by t=mT, where T is the sample period T [sec] of a digital signal and m is a positive number, and letting the input signal xₙ(m) of an nth channel be represented by a complex amplitude, the input signal to the input side digital multi-port directional coupler 13 is expressed by the following matrix.

X(m)=(x₁(m)x₂(m), . . . , x_{N}(m))^{T} (5)

where ^{T} represents a transposition. The input signal X(m) is transformed by the N-channel input side digital multi-port directional coupler 13 through use of Eq. (4) to an output signal Y(m) as given by the following equations.

Y(m)=TₙX(m) (6)

Y(m)=(y₀(m)y₁(m), . . . , y_{N-1}(m))^{T} (7)

Letting F represent a waveform transformation matrix of predistorters 21₁, . . . , 21_{N}, Y(m) is transformed to Z(m).

Z(m)=F(Y(m))Y(m) (8)

$$Z ( m ) = [ \begin{matrix}f ( {y}_{0} ( m ) ) & 0 & 0 & 0 \\ 0 & f ( {y}_{1} ( m ) ) & 0 & 0 \\ 0 & 0 & ⋰ & 0 \\ 0 & 0 & 0 & f ( {y}_{N - 1} ( m ) )\end{matrix} ] [ \begin{matrix}{y}_{0} ( m ) \\ {y}_{1} ( m ) \\ ⋮ \\ {y}_{N - 1} ( m )\end{matrix} ] \qquad ( 9 )$$

The signal Z(m) is used to perform processing in the input side digital multi-port directional coupler 13 and the predistorters 21₁, . . . , 21_{N} by digital signal processing. Let Z(t) represent a matrix of analog signals converted by the DA converters 22₁, . . . , 22_{N} from the signal Z(m). Respective elements of the signal matrix Z(t) are subjected to frequency conversion to the transmission frequency band and power amplification in the transmitting parts 30₁, . . . , 30_{N}. The power-amplified signals of N channels are transformed by the output side multi-port directional coupler 40 to transmission signals U(t)=(u₁(t), . . . , u_{N}(t)).

The predistorters 21₁, . . . , 21_{N} monitor the amplified output signals and adaptively update the coefficients of the waveform transformation matrix F by digital processing so as to achieve predetermined nonlinear distortion characteristics.

The production of the signal Z(m) by the above processing allows complete elimination of imperfection of the operating characteristic of the input side multi-port directional coupler 13 formed by analog circuitry. Further, it is possible to perform generation of the signals X(m) to Z(m) by digital signal processing. Since the above-described digital signal processing can be achieved by such software as DSP (Digital Signal Processor), the circuit configuration by the present invention can be implemented with more ease than the conventional configuration analog circuitry. Besides, since the input side multi-port directional coupler, which is formed by an analog circuit in the prior art, is implemented by digital signal processing, the gain and phase deviations between the output ports can be reduced to zero. Zeroing the gain and phase deviations in the analog circuit configuration is impossible in terms of circuit fabrication accuracy. Accordingly, digital signal processing permits simplification of the circuit adjustment as compared with the conventional analog circuit configuration.

First Embodiment

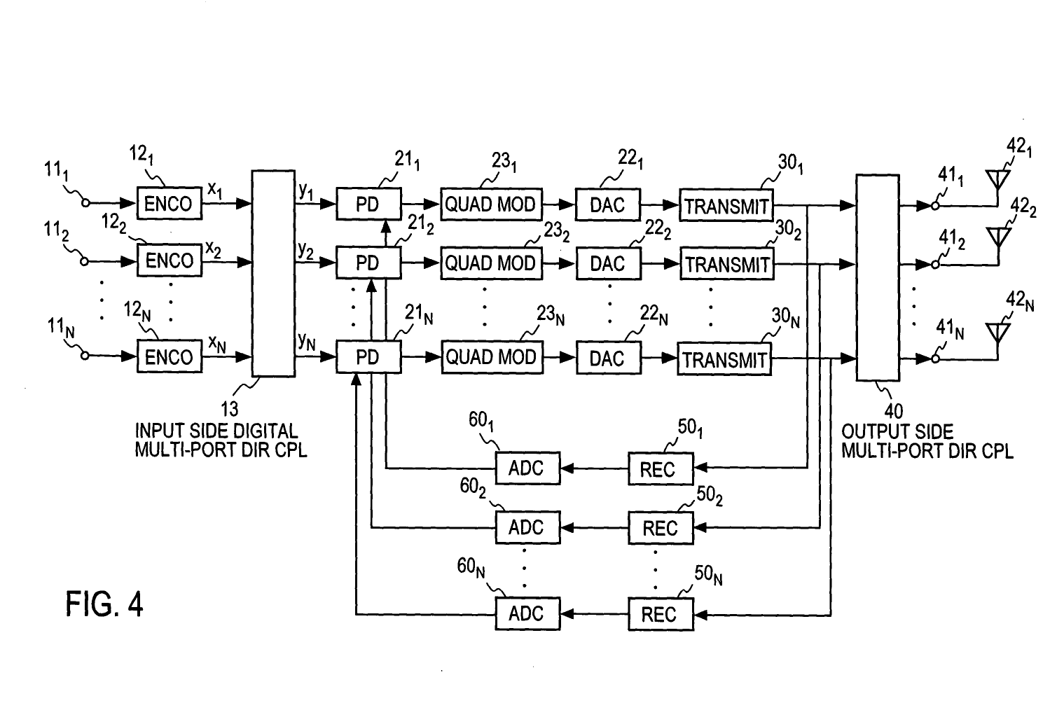

FIG. 4 illustrates the configuration of a first embodiment of the transmitter according to the present invention.

The transmitter comprises: encoders 12₁, . . . , 12_{N} of N channels; an input side digital multi-port directional coupler 13; predistorters 21₁, . . . , 21_{N}; quadrature modulators 23₁, . . . , 23_{N}; DA converters 22₁, . . . , 22_{N}; transmitting parts 30₁, . . . , 30_{N}; an output side multi-port directional coupler 40; receiving parts 50₁, . . . , 50_{N}; and analog-to-digital (AD) converters 60₁, . . . , 60_{N}.

The encoders 12₁, . . . , 12_{N} perform QPSK (Quadrature Phase Shift Keying) or similar encoding of a transmission digital signal sequence provided to input terminals 11₁, . . . , 11_{N}.

The input side digital multi-port directional coupler 13 inputs thereto complex signals of N channels and outputs complex signals of N channels. The processing in the input digital multi-port directional coupler 13 calculates Eq. (6) through use of the matrix defined by Eqs. (4) and (5). That is, the input side digital multi-port directional coupler 13 performs processing which multiplies the input signal matrix by the transformation matrix Tₙ starting at the left-hand side. The complex output signals of the respective channels y₁, . . . , y_{N} from the input side digital multi-port directional coupler 13 are fed to the predistorters 21₁, . . . , 21_{N}, respectively.

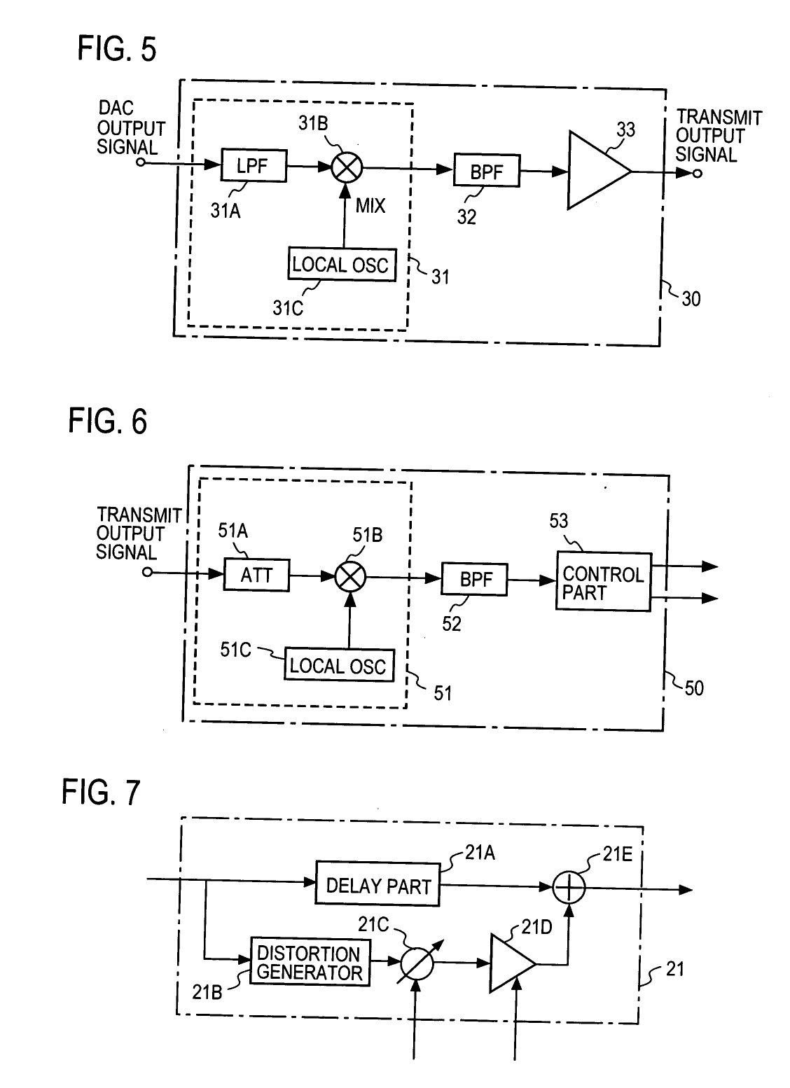

Each predistorter 21ₙ (where n=1, . . . , N) linearizes gain and phase characteristics of the signal of the corresponding channel by preimparting thereto a compensating distortion which cancels the nonlinear distortion generated by a power amplifier (FIG. 5, described later on) in the transmitting part 30ₙ. The configuration of the predistorter 21ₙ is a conventional look up table type or cuber distortion compensating type based on a power series model. The output signal from each predistorter 21ₙ is subjected to quadrature modulation by digital signal processing in the quadrature modulator 23ₙ. The output signal from the quadrature modulator 23ₙ is converted by the DA converter 22ₙ to an analog signal, which is provided to the transmitting part 30ₙ.

For example, as identified generally by 30 in FIG. 5, each transmitting part 30ₙ comprises: a frequency up-converting part 31 made up of a band-limiting low-pass filter 31A, a mixer 31B and a local oscillator 31C; a band-pass filter 32; and a power amplifier 33. In the transmitting part 30 the AD converter output signal is up-converted by being mixed with a high-frequency (RF) carrier signal generated by the local oscillator 31C, and a signal of the RF transmission frequency band is extracted by the band-pass filter 32 and subjected to power amplification by the power amplifier 33. The power-amplified high-frequency transmission signal is transmitted via an antenna 42ₙ. For example, as identified generally by 50 in FIG. 6, each receiving part 50ₙ comprises: a detecting part 51 made up of an attenuator 51A, a mixer 51B and a local oscillator 51C; a band-pass filter 52; and a control part 53.

As depicted in FIG. 6, in each receiving part 50ₙ a portion of the power of the output signal from the transmitting part 30ₙ of the corresponding channel is detected by the mixer 51B and the local oscillator 51C via the attenuator 51A, and the detected signal is applied to the band-pass filter 52 to extract the distortion component generated by the power amplifier 33. Based on the extracted distortion component, the control part 53 generates a correcting signal, which is provided to the AD converter 61ₙ (FIG. 4). The correcting signal converted by the AC converter 61ₙ to digital form is applied to the predistorter 21ₙ to adjust its gain and phase characteristics to minimize the above-mentioned extracted distortion component, providing predetermined linearity of the transmitting part 30ₙ.

FIG. 7 illustrates in block form an example of the predistorter 21ₙ (identified by 21). A wide variety of predistorters have already been proposed; the predistorter of this example is a digital predistorter using a power series model. The illustrated predistorter is configured to add together signals from a delay path which passes therethrough the fundamental wave component of the transmission signal, and on a path for generating an odd-order distortion based on power series. That is, the predistorter 21 of this example is made up of a delay part 21A, a distortion generator 21B, a phase adjuster 21C, a gain adjuster 21D and an adder 21E. The fundamental wave component of the transmission signal is fed to the adder 21E via the delay part 21A wherein it is delayed by the same time interval as the delay time of the distortion generating path. The distortion generator 21B generates a power series-based odd-order distortion, for example, third-order distortion, of the transmission signal. This odd-order distortion is adjusted in phase by the phase adjuster 21C and then adjusted in gain by the gain adjuster 21D, thereafter being added to the fundamental wave component by the adder 21E. The adder output is provided as the output from the predistorter 21 to the transmitting part 30ₙ via quadrature modulator 23ₙ and the DA converter 22ₙ of the corresponding channel. Incidentally, the distortion generator may configured to generate the third-, fifth-, or seventh-order distortion, or a desired combination of them.

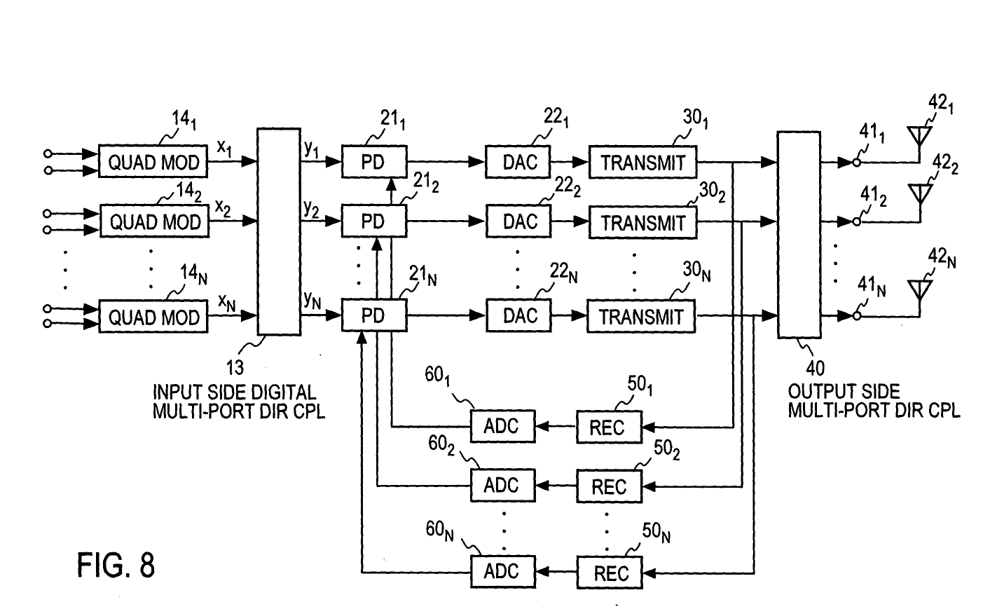

By the phase and gain correcting signals provided thereto via the AD converter 60ₙ (FIG. 4) from the control part 53 of the receiving part 50, the phase adjuster 21C an the gain adjuster 21D are adjusted to adjust the phase and gain of the odd-order distortion. The correcting signals provide coefficients for adjusting the phase adjuster 21C and the gain adjuster 21D, and define the waveform transformation matrix F of the predistorter in Eqs. (8) and (9). The control part 53 may also be implemented by digital signal processing. In such an instance, each AD converter 60ₙ in FIGS. 4 and 8 is inserted between the band-pass filter 52 and the control part 53 in the receiving part 50ₙ of FIG. 6 to convert the distortion component extracted by the band-pass filter 52 to a digital signal, and the control part 53 generates a digital correcting signal based on the digital distortion component.

In the FIG. 4 embodiment the encoders 12₁, . . . , 12_{N} to the quadrature modulators 23₁, . . . , 23_{N} are implemented by integrated digital signal processing. For example, in the case of a digital signal processing system which operates in real time, the functions of the encoders 12₁, . . . , 12_{N} to the quadrature modulators 23₁, . . . , 23_{N} can be implemented as software. It is also possible to implement the functions of the encoders 12₁, . . . , 12_{N} to the quadrature modulators 23₁, . . . , 23_{N} by use of such hardware logic as FPGA (Field Programmable Gate Array). This embodiment permits programmable implementation of the functions of the encoders 12₁, . . . , 12_{N} to the quadrature modulators 12₁, . . . , 23_{N}, and allows resetting of their functions adaptively or according to the circumstances. Accordingly, it is possible to cope with a plurality of modulation schemes and a plurality of predistortion schemes by use of the same DSP or FPGA hardware configuration. The input side digital multi-port directional coupler 13 and the predistorters 21₁, . . . , 21_{N} may also be implemented by independent control programs. Besides, the control programs for the input side multi-port directional coupler 13 and the predistorters 21₁, . . . , 21_{N} may be implemented by a single controller.

In the conventional multi-port amplifier configuration the input side digital multi-port directional coupler 13 and the output side multi-port directional coupler 40 are both implemented by analog circuits. The present invention implements the input side digital multi-port directional coupler 13 by digital signal processing as expressed by Eqs. (5) and (6). This eliminates the need for adjusting the gain and phase deviations between respective channels to be smaller than design values so as to provide a predetermined or greater degree of isolation between the output ports of the input side multi-port directional coupler as required in the prior art. That is, the present invention ensures complete isolation between the output ports of the input side directional coupler without any adjustment and hence enables the gain and phase deviations to be made zero. Accordingly, the present invention needs only adjustment of the output side multi-port directional coupler and provides an increased degree of isolation of the multi-port configuration by less adjustment than in the prior art.

Second Embodiment

FIG. 8 illustrates in block form a second embodiment of the transmitter according to the present invention.

The illustrated transmitter comprises: quadrature modulators 14₁, . . . , 14_{N} for quadrature modulation of input digital IQ signals; an input side digital multi-port directional coupler 13; predistorters 21₁, . . . , 21_{N}; DA converters 22₁, . . . , 22_{N}; transmitting parts 30₁, . . . , 30_{N}; an output side multi-port directional coupler 40; receiving parts 50₁, . . . , 50_{N}; and AD converters 60₁, . . . , 60_{N}. Each transmitting part 30_{N} has the afore-mentioned configuration of FIG. 5, each receiving part 50_{N} has the afore-mentioned configuration of FIG. 6, and each predistorter 21_{N} has the afore-mentioned configuration of FIG. 7. This embodiment is identical in construction with the FIG. 4 embodiment except the above.

This embodiment differs from the first embodiment in that the input digital multi-port directional coupler 13 and the predistorters 21₁, . . . , 21_{N} perform processing of the digital signals x₁, . . . , x_{N} subjected to quadrature modulation by the quadrature modulators 14₁, . . . , 14_{N}. This embodiment is identical in operation and effect with the first embodiment. The configurations of the first and second embodiments implement the input side digital multi-port directional coupler 13 and the predistorters 21₁, . . . , 21_{N} through digital signal processing, thereby permitting simplification, miniaturization and weight reduction of the device configuration as compared with the conventional multi-port configuration.

Third Embodiment

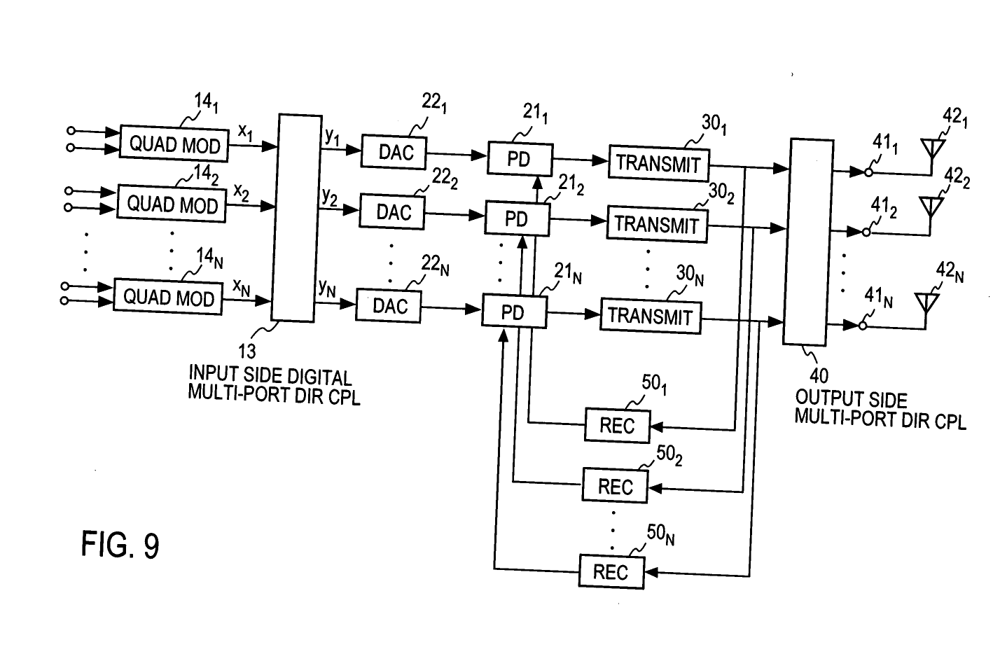

FIG. 9 illustrates in block form of the FIG. 8 embodiment. While the first and second embodiments have been described to implement the predistorters 21₁, . . . , 21_{N} by digital signal processing, they may also be formed by analog circuits as depicted in FIG. 9. In this case, the predistorters 21₁, . . . , 21_{N} are inserted between the DA converters 22₁, . . . , 22_{N} and the transmitting parts 30₁, . . . , 30_{N}, respectively, and the distortion components extracted in the receiving parts 50₁, . . . , 50_{N} are applied as correcting signals in analog form to the predistorters 21₁, . . . , 21_{N}, respectively. In this embodiment, since the predistorters 21₁, . . . , 21_{N} are formed by analog circuits, the transmitter configuration becomes larger than in the case of the FIG. 8 embodiment, but digital processing in the input side digital multi-port directional coupler 13 produces the intended effect.

In the first, second and third embodiments adaptive array antenna or sector antenna can be used as each of the antennas 42₁, . . . , 42_{N} which are supplied with the output from the output side multi-port directional coupler 40. Further, a duplexer or switch commonly used in radio stations may also be provided between the output side multi-port directional coupler 40 and each of the antennas 42₁, . . . , 42_{N} so that a receiver (not shown) is used also as an antenna.

### EFFECT OF THE INVENTION

As described above, according to the present invention, the implementation of the input-side multi-port directional coupler and the predistorters by digital signal processing produces such effects as (1) miniaturization of the transmitter and (2) facilitation of adjustment of the multi-port configuration.

What is claimed is:

1. A transmitter comprising:
an input-side digital multi-port directional coupler for dividing and combining digital transmission signals of N channels by digital processing and for outputting N-channel signals to N transmission channels, respectively;
predistorters inserted in said N transmission channels, respectively, for linearizing said N transmission channels;
transmitting parts inserted in said N transmission channels, respectively, for converting output signals from said predistorters to high-frequency signals of said N channels; and
an output-side multi-port power combiner for dividing and combining said high-frequency signals of said N-transmission channels to output high-frequency transmission signals for said N transmission channels.

2. The transmitter of claim 1, which further comprises receiving parts of said N channels for extracting distortion components from said high-frequency signals of N channels and for generating, based on said distortion components, compensating signals which control said linearization by said predistorters of N channels, and wherein, based on said compensating signals, said predistorters of N channels generate compensating distortions for canceling nonlinear distortions by said N transmission channels and impart said compensating distortions to signals of N channels, respectively.

3. The transmitter of claim 2, wherein said predistorters of N channels are digital predistorters of N channels for imparting said compensating distortions to said signals of N channel by digital processing, and which further comprises: digital-to-analog converters of N channels for converting the outputs from said predistorters of N channels to analog signals of N channels and for applying said analog signals of N channels to said transmitting parts of N channels, respectively; and digital-to-analog converters of N channels for converting said compensating signals from said receiving parts of N channels to digital compensating signals and for applying said digital compensating signals to said digital predistorters of N channels.

4. The transmitter of claim 2, wherein said predistorters of N channels are analog predistorters, and which further comprises digital-to-analog converters of N channels for converting said signals of N channels output from said input side digital multi-port directional coupler to analog signals for application to said digital predistorters of N channels, said receiving parts of N channels providing said compensating signals to said digital predistorters.

5. The transmitter of claim 3 or 4, wherein each of said transmitting parts of N channels includes: an up-converting part for the corresponding one of said signals of N channels to a high-frequency signal of the transmission frequency band; and a power amplifier for amplifying the power of said high-frequency signal and for applying said power-amplified high-frequency signal to said output side multi-port directional coupler.

6. The transmitter of claim 3 or 4, wherein each of said receiving parts of N channels includes: a detecting part for detecting the corresponding one of said high-frequency signals of N channels; a band-pass filter for extracting a distortion component by said power amplifier from said detected output; and a control part for generating said compensating signal based on said distortion component.
